(19) United States
(12) Patent Application Publication
(10) Pub. No.: US 2011/0291961 A1
(43) Pub. Date: Dec. 1, 2011

(54) TOUCH-SENSING DISPLAY PANEL

(75) Inventors: Ming-Lun Hsieh, Taoyuan County (TW); Po-Yuan Liu, Hsinchu City (TW)

(73) Assignee: AU OPTRONICS CORPORATION, Hsinchu (TW)

(21) Appl. No.: 12/908,003

(22) Filed: Oct. 20, 2010

(30) Foreign Application Priority Data
May 28, 2010 (TW) 99117177

(51) Int. Cl. G06F 3/041

(52) U.S. Cl. 345/173

(57) ABSTRACT

A touch-sensing display panel includes a panel and a touch-sensing layer. The panel has a display region and a non-display region. The touch-sensing layer overlaps the display region and the non-display region.

### CROSS-REFERENCE TO RELATED APPLICATION

This application claims the priority benefit of Taiwan application serial no. 99117177, filed on May 28, 2010. The entirety of the above-mentioned patent application is hereby incorporated by reference herein and made a part of this specification.

### BACKGROUND OF THE INVENTION

1. Field of the Present Invention

The present invention relates to a display panel, and in particular to a touch-sensing display panel.

2. Description of Related Art

With development of information technology, wireless mobile communication, and information appliances, input devices of various information products including conventional key boards or mice have been replaced by touch-sensing display panels in order to comply with requirements for portability, compactness, and user-friendly interfaces. In general, based on different sensing modes, the touch-sensing display panel can be roughly categorized into resistant touch-sensing display panels, capacitive touch-sensing display panels, optical touch-sensing display panels, acoustic wave touch-sensing display panels, electromagnetic touch-sensing display panels, and so forth. Here, the capacitive touch-sensing display panels can be further classified into self capacitive touch-sensing display panels and mutual capacitive touch-sensing display panels based on sensing methods and the manner in which the panels are driven.

In most cases, a touch-sensing display panel includes a display panel and a touch-sensing panel, and the touch-sensing panel can be built in or attached to the display panel. The display panel includes an active region and a peripheral region. The touch-sensing panel usually includes a plurality of first touch-sensing series extending along the X direction and a plurality of second touch-sensing series extending along the Y direction. Each of the first touch-sensing series has a plurality of first electrodes serially connected to one another, and each of the second touch-sensing series has a plurality of second electrodes serially connected to one another. When a user touches the touch panel with his or her finger, capacitance between the first and the second electrodes is changed, and a signal indicating such a change is transmitted to a controller, so as to calculate the coordinate of the touched location. Thereby, a display image on the display panel can be changed when the user selects a location to perform the touch action.

A touch-sensing layer of the touch-sensing panel is frequently disposed corresponding to the display region of the display panel. That is to say, the touch-sensing series are correspondingly formed in the active region of the display panel. As such, given the user's finger comes into contact with an edge area of the display region, the sensing signal is unlikely to be triggered or is relatively weak because the edge area is located at boundaries of the touch-sensing series. As a result, the touched location cannot be recognized.

### SUMMARY OF THE INVENTION

The present invention is directed to a touch-sensing display panel capable of sensing touch actions at a display region and at an edge area of the display region.

In the present invention, a touch-sensing display panel including a panel and a touch-sensing layer is provided. The panel has a display region and a non-display region. The touch-sensing layer overlaps the display region and the non-display region.

According to an embodiment of the present invention, the touch-sensing layer includes a plurality of first touch-sensing series and a plurality of second touch-sensing series. The first touch-sensing series extend along a first direction, and each of the first touch-sensing series includes a plurality of first touch-sensing pads electrically connected to one another. The second touch-sensing series extend along a second direction, and each of the second touch-sensing series includes a plurality of second touch-sensing pads electrically connected to one another. The first direction is different from the second direction, and the first touch-sensing series are electrically insulated from the second touch-sensing series.

According to an embodiment of the present invention, the touch-sensing layer includes a plurality of inner electrode series and a plurality of outer electrode series. The inner electrode series extend along a first direction, and each of the inner electrode series includes a plurality of inner electrodes electrically connected to one another. The outer electrode series extend along a second direction, and each of the outer electrode series includes a plurality of outer electrodes electrically connected to one another. Each of the inner electrodes is respectively surrounded by one of the outer electrodes. The first direction is different from the second direction. The inner electrode series are electrically insulated from the outer electrode series.

Based on the above, the touch-sensing layer of the touch-sensing display panel in the present invention overlaps the display region and the non-display region. Namely, the touch-sensing layer is disposed corresponding to the display region and extends out of the display region. Accordingly, when the user touches the edge area of the display region, the touched location can still be detected. Thus, the touch-sensing display panel of the present invention is characterized by favorable touch-sensing capacity.

It is to be understood that both the foregoing general descriptions and the following detailed embodiments are exemplary and are, together with the accompanying drawings, intended to provide further explanation of technical features and advantages of the present invention.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the present invention.

FIG. 1A is a schematic cross-sectional view illustrating a touch-sensing display panel according to an embodiment of the present invention.

FIG. 1B is a schematic top view illustrating the touch-sensing layer depicted in FIG. 1A.

FIG. 1C is a schematic partially enlarged view of FIG. 1B.

FIG. 1D is a schematic cross-sectional view taken along a line I-I′ depicted in FIG. 1C.

FIG. 1E is a schematic cross-sectional view taken along a line A-A′ depicted in FIG. 1C.

FIG. 2 is a schematic top view illustrating a touch-sensing layer of a touch-sensing display panel according to an embodiment of the present invention.

FIG. 3 is a schematic top view illustrating a touch-sensing layer of a touch-sensing display panel according to an embodiment of the present invention.

FIG. 4 is a schematic top view illustrating a touch-sensing layer of a touch-sensing display panel according to an embodiment of the present invention.

FIG. 5 is a schematic cross-sectional view illustrating a touch-sensing display panel according to an embodiment of the present invention.

FIG. 6 is a schematic cross-sectional view illustrating a touch-sensing display panel according to an embodiment of the present invention.

FIG. 7A is a schematic cross-sectional view illustrating a touch-sensing display panel according to an embodiment of the present invention.

FIG. 7B is a schematic top view illustrating the touch-sensing layer depicted in FIG. 7A.

FIG. 7C is a schematic cross-sectional view taken along a line I-I′ in FIG. 7B.

### DESCRIPTION OF EMBODIMENTS

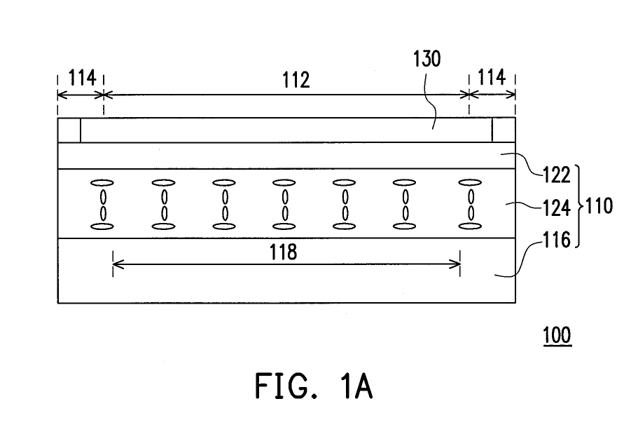

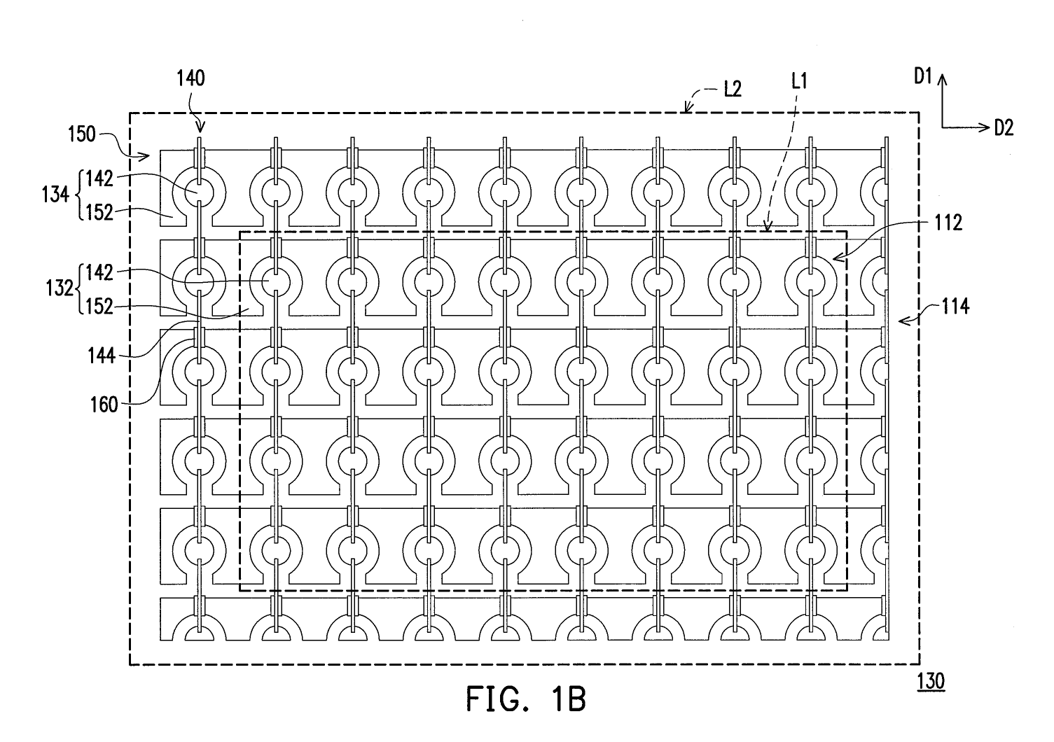

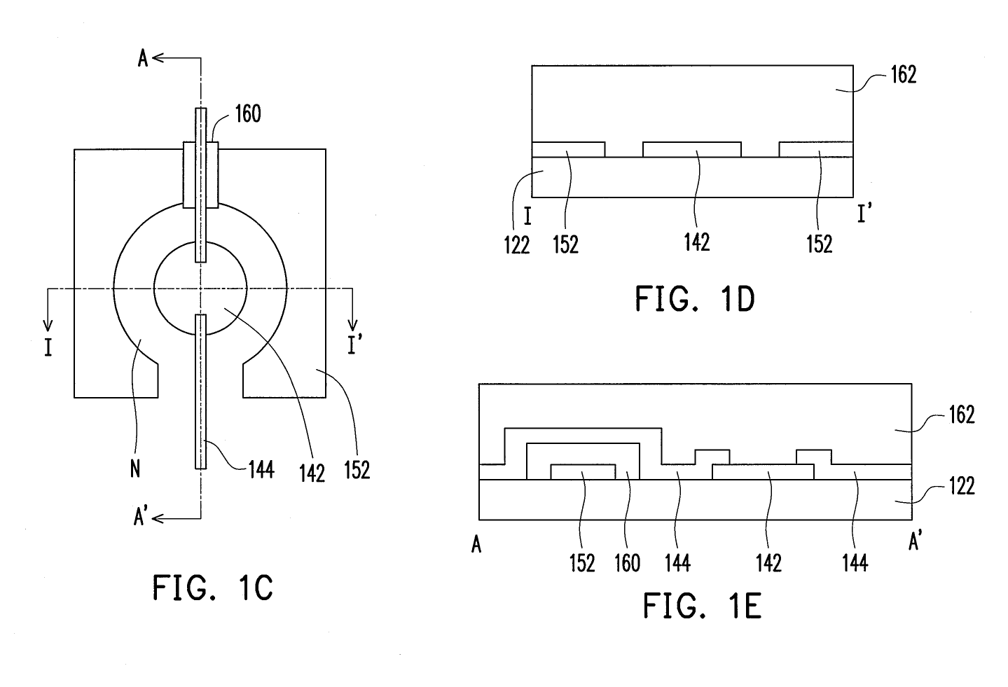

FIG. 1A is a schematic cross-sectional view illustrating a touch-sensing display panel according to an embodiment of the present invention. FIG. 1B is a schematic top view illustrating the touch-sensing layer depicted in FIG. 1A. FIG. 1C is a schematic partially enlarged view of FIG. 1B. FIG. 1D and FIG. 1E are schematic cross-sectional views respectively taken along a line I-I′ and a line A-A′ depicted in FIG. 1C. As indicated in FIG. 1A and FIG. 1B, a touch-sensing display panel 100 includes a panel 110 and a touch-sensing layer 130. The panel 100 has a display region 112 and a non-display region 114, and the non-display region 114 surrounds the display region 112, for instance. According to this embodiment, the display region 112 is surrounded by dotted lines L1 depicted in FIG. 1B, and the non-display region 114 is defined by dotted lines L1 and L2. The touch-sensing layer 130 at least partially overlaps the display region 112 and the non-display region 114.

In this embodiment, the panel 110 includes an active device array substrate 116, an opposite substrate 122, and a display medium layer 124. The display medium layer 124 is located between the active device array substrate 116 and the opposite substrate 122. The active device array substrate 116 includes an active region 118. Here, the display region 112 of the panel 110 corresponds to the active region 118 and overlaps the active region 118, and the non-display region 114 corresponds to areas outside the active region 118, for example. In other words, images are displayed on the display region 112 of the panel 110, and words or letters can be chosen from or input to the display region 112. By contrast, the non-display region 114 is covered by frames (not shown) or similar components and is thus not seen by the user. The opposite substrate 122 of this embodiment is a color filter substrate, for instance.

With reference to FIG. 1A to FIG. 1C, in this embodiment, the touch-sensing layer 130 is located on the panel 110, for example. In other words, the touch-sensing layer 130, for instance, is formed on an outer surface of the opposite substrate 122, and the opposite substrate 122 is located between the active device array substrate 116 and the touch-sensing layer 130. The touch-sensing layer 130 is disposed corresponding to the display region 112 and extends from the display region 112 to a portion of the non-display region 114, such that the touch-sensing layer 130 at least partially overlaps the display region 112 and the non-display region 114. According to this embodiment, the touch-sensing layer 130 includes a plurality of inner electrode series 140 and a plurality of outer electrode series 150, for example. The inner electrode series 140 extend along a first direction D1, and each of the inner electrode series 140 includes a plurality of inner electrodes 142 and a plurality of bridge lines 144 disposed among the inner electrodes 142. The inner electrodes 142 are electrically connected to one another through the bridge lines 144. The outer electrode series 150 extend along a second direction D2, and each of the outer electrode series 150 includes a plurality of outer electrodes 152 electrically connected to one another. Each of the inner electrodes 142 is surrounded by one of the outer electrodes 152, respectively. A width (e.g. a diameter) of the inner electrodes 142 ranges from about 0.7 cm to about 1.0 cm, for example. A material of the inner electrodes 142 and the outer electrodes 152 is, for example, a transparent conductive material, and a material of the bridge lines 144 is, for example, a transparent conductive material or a non-transparent conductive material. Here, the first direction D1 is different from the second direction D2. The first direction D1 is the Y direction, and the second direction D2 is the X direction, for instance. Besides, the first direction D1, for example, is substantially perpendicular to the second direction D2. In this embodiment, the inner electrode series 140 are electrically insulated from one another, and the outer electrode series 150 are electrically insulated from one another. Additionally, the inner electrode series 140 are electrically insulated from the outer electrode series 150.

As indicated in FIG. 1D and FIG. 1E, the touch-sensing layer 130 can further include a patterned dielectric layer 160 and a passivation layer 162. The patterned dielectric layer 160 is substantially located at intersections of the inner electrode series 140 and the outer electrode series 150, such that the inner electrode series 140 are electrically insulated from the outer electrode series 150. The passivation layer 162 covers the inner electrode series 140 and the outer electrode series 150, such that the inner electrode series 140 and the outer electrode series 150 do not come into contact with external surroundings and are not damaged thereby.

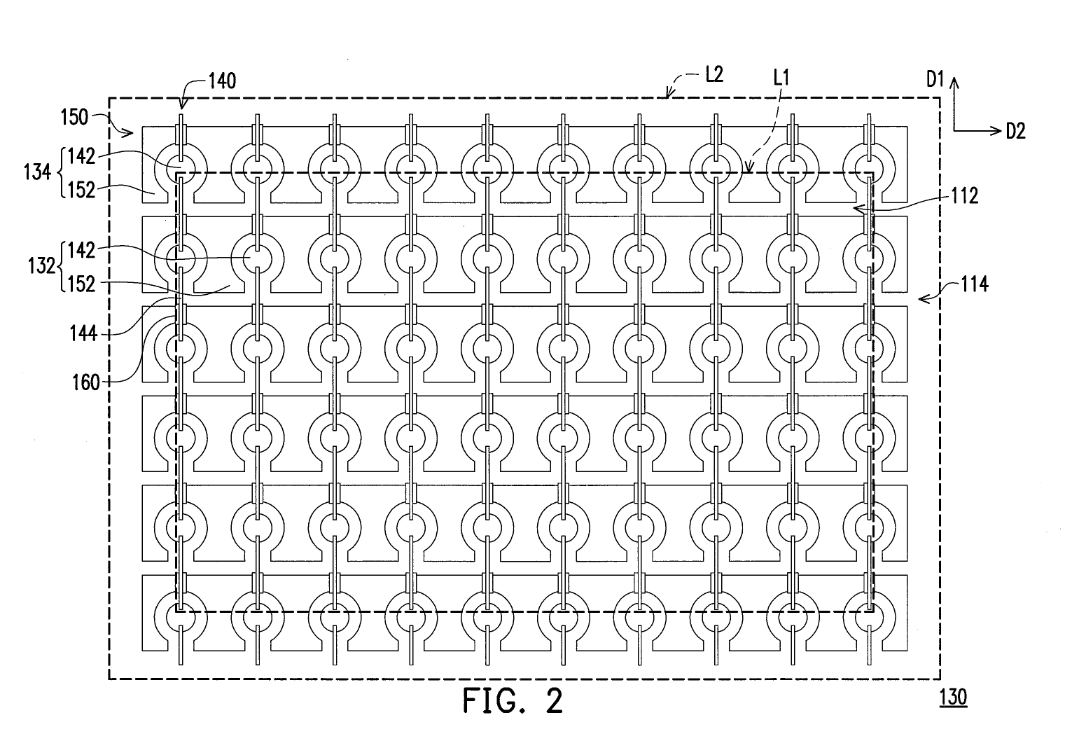

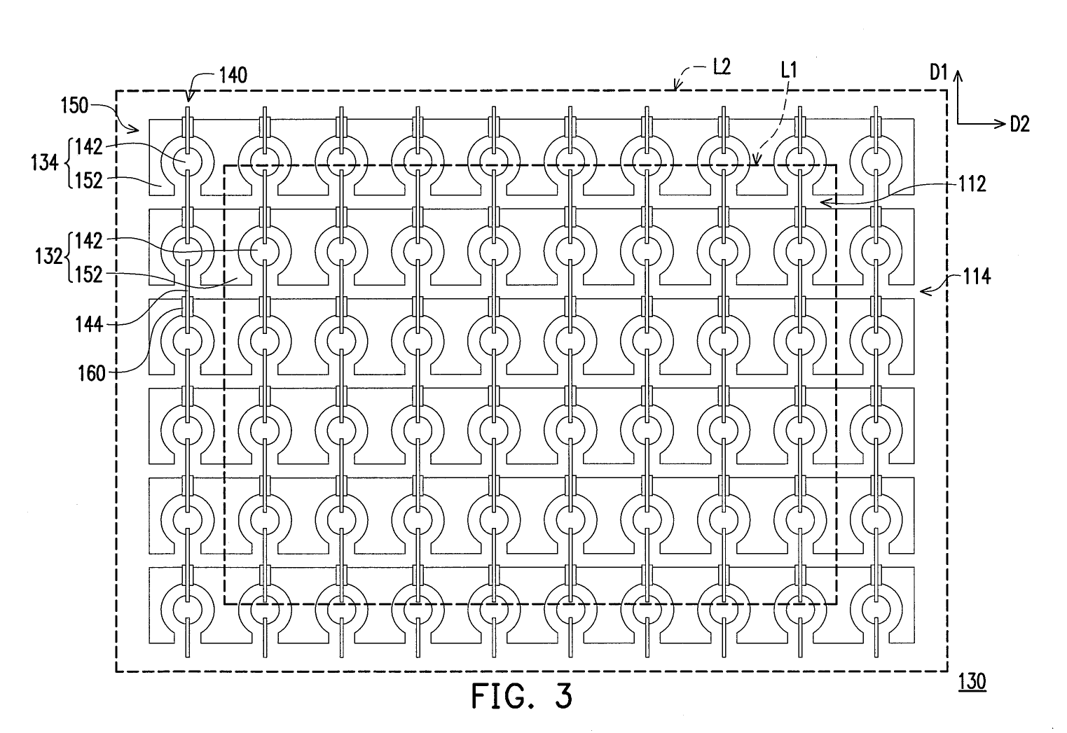

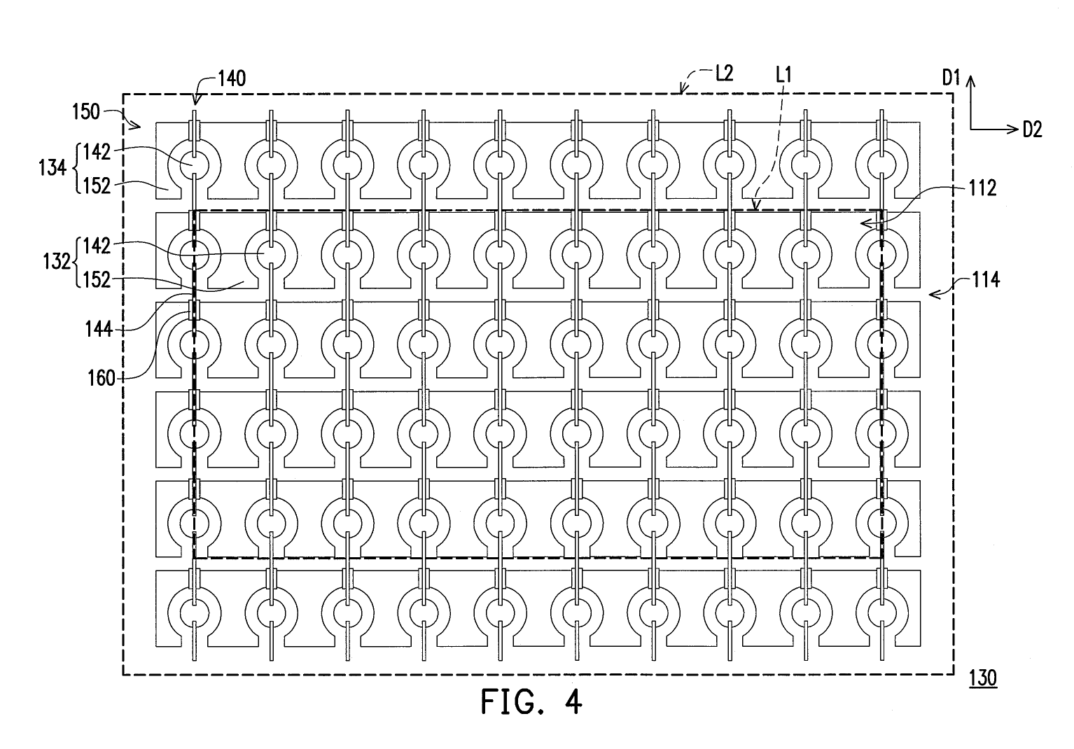

With reference to FIG. 1B, each of the outer electrodes 152 and each of the inner electrodes 142 correspondingly disposed within the display region 112 together form a touch-sensing unit 132, and each of the outer electrodes 152 and each of the inner electrodes 142 correspondingly disposed within the non-display region 114 together form an auxiliary touch-sensing unit 134, for instance. In one of the inner electrode series 140 of this embodiment, parts of the inner electrodes 142 are located within the display region 112, while the other parts of the inner electrodes 142 are located within the non-display region 114. Similarly, in one of the outer electrode series 150 of this embodiment, parts of the outer electrodes 152 are located within the display region 112, while the other parts of the outer electrodes 152 are located within the non-display region 114. Namely, the touch-sensing layer 130 includes a plurality of touch-sensing units 132 and a plurality of auxiliary touch-sensing units 134. The touch-sensing units 132 are correspondingly disposed in the display region 112, and the auxiliary touch-sensing units 134 are correspondingly disposed in the non-display region 114. A dimension of the auxiliary touch-sensing units 134 can be substantially equal to or smaller than a dimension of the touch-sensing units 132, and the dimension herein refers to width, length, area, or any other feature size, for example. In this embodiment, a width of the touch-sensing units 132 ranges from about 0.7 cm to about 1.0 cm, for example. A dimension of parts of the auxiliary touch-sensing units 134 (e.g. the auxiliary touch-sensing units 134 located at the upper and left sides in FIG. 1B) is substantially equal to the dimension of the touch-sensing units 132, for example, and a dimension of the other parts of the auxiliary touch-sensing units 134 (e.g. the auxiliary touch-sensing units 134 located at the lower and right sides in FIG. 1B) is smaller than the dimension of the touch-sensing units 132, for example. As shown in FIG. 1B, it should be mentioned that the inner electrodes 142 of the inner electrode series 140 and the outer electrodes 152 of the outer electrode series 150 respectively correspond to the touch-sensing units 132 and the auxiliary touch-sensing units 134 that are respectively located in the display region 112 and the non-display region 114 according to this embodiment. However, in other embodiments, the inner electrode series 140 and the outer electrode series 150 can be arranged in other manner based on the arrangement of the display region 112 and the non-display region 114 of the touch-sensing display panel 100. For instance, the inner electrode series 140 and the outer electrode series 150 in the touch-sensing layer 130 can be categorized into the touch-sensing units 132 and the auxiliary touch-sensing units 134 as shown in FIG. 2 to FIG. 4, and the dimension of the auxiliary touch-sensing units 134, for example, is substantially equal to or smaller than the dimension of the touch-sensing units 132.

In this embodiment, the display medium layer 124 is made of a liquid crystal material, for example. Namely, the touch-sensing display panel 100 of this embodiment is, for instance, a liquid crystal touch-sensing display panel. The display medium layer 124 can also be made of other display materials, such as an organic light emitting material, an electrophoretic display material, or a plasma display material. That is to say, the touch-sensing display panel 100 can be an organic electro-luminescent touch-sensing display panel, an electrophoretic touch-sensing display panel, or a plasma touch-sensing display panel.

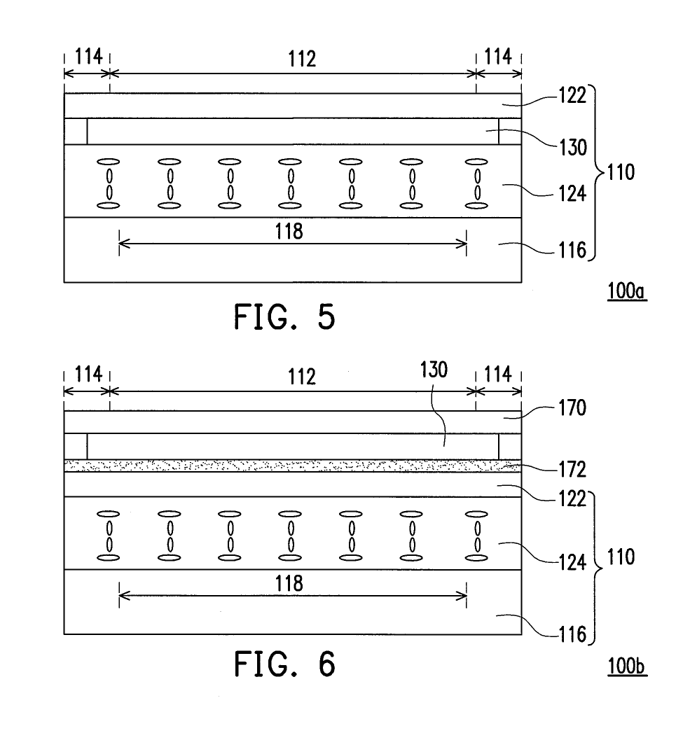

Note that the touch-sensing layer 130 of this embodiment is located on the panel 110, for example. However, in another embodiment as shown in FIG. 5, the touch-sensing layer 130 in a touch-sensing display panel 100a can be built in the panel 110. Namely, the touch-sensing layer 130 is formed on an inner surface of the opposite substrate 122, such that the touch-sensing layer 130 is located between the opposite substrate 122 and the display medium layer 124. In an alternative embodiment, as indicated in FIG. 6, the touch-sensing layer 130 can be formed on an auxiliary substrate 170, and the auxiliary substrate 170 on which the touch-sensing layer 130 is already formed is attached to an outer surface of the panel 110 by an adhesive layer 172, so as to form an added-on touch-sensing display panel 100b. That is to say, the touch-sensing layer 130 can be formed in the panel 110 or integrated into the panel 110 in various manner.

With reference to FIG. 1B, according to this embodiment, when a user touches the touch-sensing display panel 100 with his or her finger, capacitance between the inner electrodes 142 and the outer electrodes 152 of the touch-sensing units 132 is changed, and a signal indicating such a change is transmitted to a controller (not shown), so as to calculate the coordinate of the touched location. Thereby, an image displayed on the touch-sensing display panel 100 can be changed when the user selects a location to perform the touch action. In addition, when the touched location is in a region among the touch-sensing units 132 but not in an individual sensing unit 132, the controller, based on the signals retrieved by the touch-sensing units 132, performs interpolation to detect the accurate touched location, for instance.

Specifically, in this embodiment, the touch-sensing layer 130 is disposed corresponding to the display region 112 and extends out of the display region 112. Namely, the touch-sensing units 132 are disposed corresponding to the display region 112, and the auxiliary touch-sensing units 134 are disposed corresponding to the non-display region 114. Hence, even though the user's finger comes into contact with an edge area of the display image, i.e. the edge area of the display region 112, the controller is able to detect the accurate touched location by interpolation based on the signals retrieved by the touch-sensing units 132 and the auxiliary touch-sensing units 134. Thereby, the display images can be further changed. That is to say, in comparison with the conventional touch-sensing display panel that encounters an issue of not being able to recognize the touched location when the touch action is performed on the edge area of the display image, the touch-sensing display panel 100 of this embodiment is characterized by favorable touch-sensing capacity when the touch action is performed at the display region 112 and at the edge area of the display region 112. As such, it is much more convenient for the user to operate the touch-sensing display panel of the present invention.

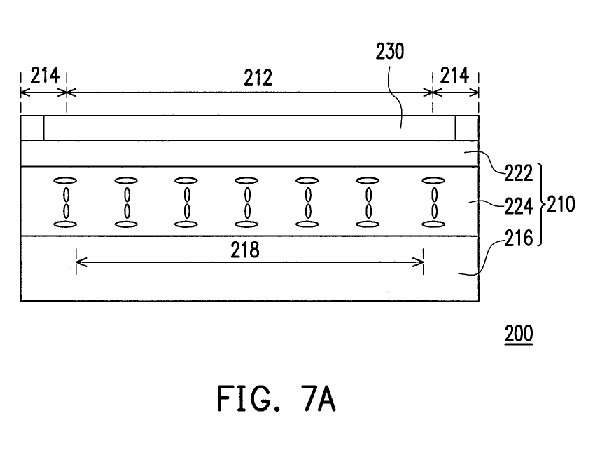

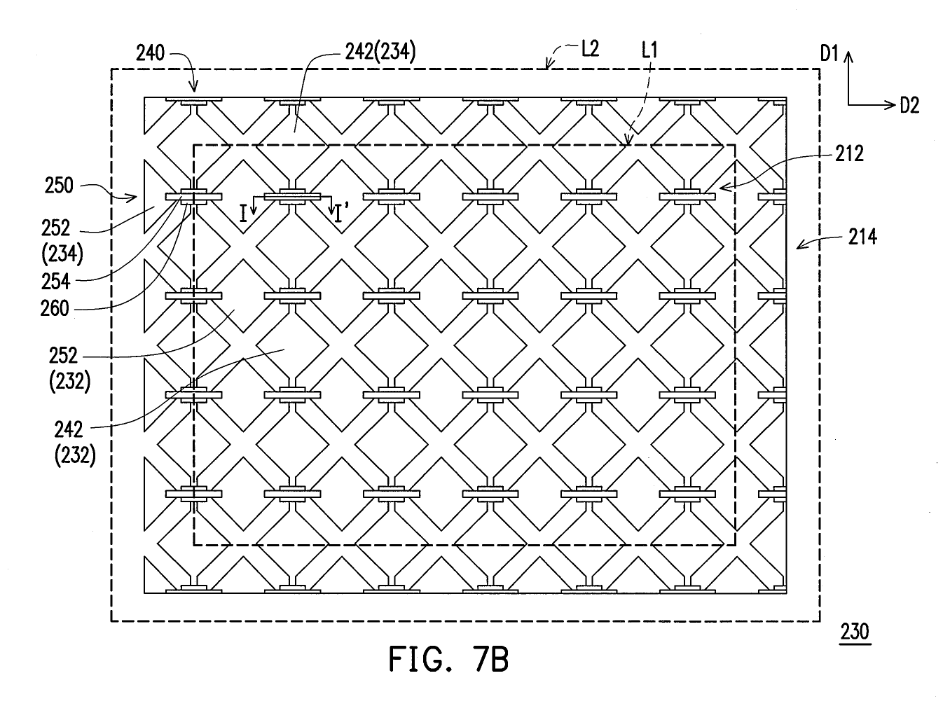

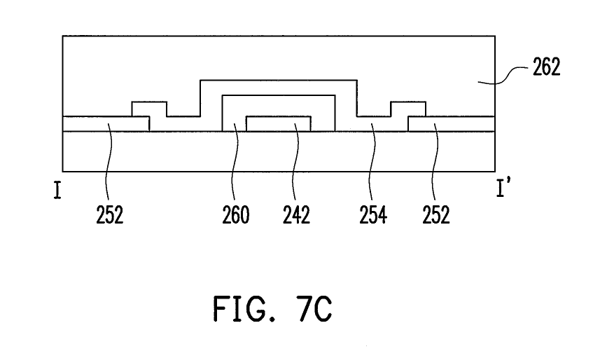

FIG. 7A is a schematic cross-sectional view illustrating a touch-sensing display panel according to an embodiment of the present invention. FIG. 7B is a schematic top view illustrating the touch-sensing layer depicted in FIG. 7A. FIG. 7C is a schematic cross-sectional view taken along a line I-I′ in FIG. 7B. As indicated in FIG. 7A and FIG. 7B, a touch-sensing display panel 200 includes a panel 210 and a touch-sensing layer 230. The panel 210 has a display region 212 and a non-display region 214, and the non-display region 214 surrounds the display region 212, for instance. According to this embodiment, the display region 212 is surrounded by dotted lines L1 depicted in FIG. 7B, and the non-display region 214 is defined by dotted lines L1 and L2. The touch-sensing layer 230 at least partially overlaps the display region 212 and the non-display region 214.

In this embodiment, the panel 210 includes an active device array substrate 216, an opposite substrate 222, and a display medium layer 224. The display medium layer 224 is located between the active device array substrate 216 and the opposite substrate 222. The active device array substrate 216 includes an active region 218. Here, the display region 212 of the panel 210 corresponds to the active region 218 and overlaps the active region 218, and the non-display region 214 corresponds to areas outside the active region 218, for example. In other words, images are displayed on the display region 212 of the panel 210, and words or letters can be chosen from or input to the display region 212. By contrast, the non-display region 214 is covered by frames (not shown) or similar components and is thus not seen by the user. The opposite substrate 222 of this embodiment is a color filter substrate, for instance. A material of the display medium layer 224 is a liquid crystal material or any other display material described in the previous embodiment, and therefore details about the material of the display medium layer 224 are not reiterated herein.

As shown in FIG. 7B and FIG. 7C, the touch-sensing layer 230 of this embodiment includes a plurality of first touch-sensing series 240 and a plurality of second touch-sensing series 250, for instance. The first touch-sensing series 240 extend along a first direction D1, and each of the first touch-sensing series 240 includes a plurality of first touch-sensing pads 242 electrically connected to one another. The second touch-sensing series 250 extend along a second direction D2. The first direction D1 is different from the second direction D2. Each of the second touch-sensing series 250 includes a plurality of second touch-sensing pads 252 and a plurality of bridge lines 254, and the second touch-sensing pads 252 are electrically connected to one another through the bridge lines 254. In this embodiment, the first touch-sensing series 240 are electrically insulated from one another, and the second touch-sensing series 250 are electrically insulated from one another. Additionally, the first touch-sensing series 240 are electrically insulated from the second touch-sensing series 250. The first touch-sensing pads 242 and the second touch-sensing pads 252 are rectangular touch-sensing pads, for instance, and a width of the first touch-sensing pads 242 and the second touch-sensing pads 252 exemplarily ranges from about 0.7 cm to about 1.0 cm. A material of the first touch-sensing pads 242 and the second touch-sensing pads 252 is, for example, a transparent conductive material, and a material of the bridge lines 254 is, for example, a transparent conductive material or a non-transparent conductive material. Besides, in this embodiment, the first direction D1 is the Y direction, and the second direction D2 is the X direction, for instance. The first direction D1, for example, is substantially perpendicular to the second direction D2. Certainly, according to other embodiments of the present invention, the included angles between the first direction D1 and the second direction D2 can have other values. Additionally, notwithstanding the first touch-sensing pads 242 and the second touch-sensing pads 252 are rectangular touch-sensing pads in this embodiment, the first touch-sensing pads 242 and the second touch-sensing pads 252 can have other shapes in other embodiments.

As indicated in FIG. 7C, the touch-sensing layer 230 can further include a patterned dielectric layer 260 and a passivation layer 262. The patterned dielectric layer 260 is substantially located in the area of intersections of the first touch-sensing series 240 and the second touch-sensing series 250, and the patterned dielectric layer 260 is substantially located between the first touch-sensing series 240 and the second touch-sensing series 250, such that the first touch-sensing series 240 are electrically insulated from the second touch-sensing series 250. The passivation layer 262 covers the first touch-sensing series 240 and the second touch-sensing series 250. Additionally, even though the touch-sensing layer 230 is formed on the panel 210 in this embodiment, the touch-sensing layer 230 can also be formed in the panel 210, so as to form a structure similar to that depicted in FIG. 5. Alternatively, the touch-sensing layer 230 can be formed on an auxiliary substrate and then bonded to the panel 210, so as to form a structure similar to that depicted in FIG. 6.

With reference to FIG. 7B, based on the locations of the first and the second touch-sensing pads 242 and 252, the first touch-sensing pads 242 and the second touch-sensing pads 252 of the touch-sensing layer 230 can be categorized into touch-sensing units 232 and auxiliary touch-sensing units 234. The touch-sensing units 232 refer to the first touch-sensing pads 242 and the second touch-sensing pads 252 correspondingly disposed in/within the display region 212, and the auxiliary touch-sensing units 234 refer to the first touch-sensing pads 242 and the second touch-sensing pads 252 correspondingly disposed in/within the non-display region 214. Namely, the touch-sensing layer 230 includes a plurality of touch-sensing units 232 and a plurality of auxiliary touch-sensing units 234. The touch-sensing units 232 are correspondingly disposed in/within the display region 212, and the auxiliary touch-sensing units 234 are correspondingly disposed in/within the non-display region 214. A dimension of the auxiliary touch-sensing units 234 can be substantially equal to or smaller than a dimension of the touch-sensing units 232, and the dimension herein refers to width, length, area, or any other feature size, for example. In this embodiment, a dimension of parts of the auxiliary touch-sensing units 234 is substantially equal to the dimension of the touch-sensing units 232, for example, and a dimension of the other parts of the auxiliary touch-sensing units 234 is smaller than the dimension of the touch-sensing units 232, for example. As shown in FIG. 7B, it should be mentioned that the first touch-sensing series 240 and the second touch-sensing series 250 are categorized into the touch-sensing units 232 and the auxiliary touch-sensing units 234 respectively located in the display region 212 and the non-display region 214 according to this embodiment. However, in other embodiments, the first touch-sensing series 240 and the second touch-sensing series 250 can be categorized into the touch-sensing units 232 and the auxiliary touch-sensing units 234 in other manner based on the arrangement of the display region 212 and the non-display region 214 of the touch-sensing display panel 200.

With reference to FIG. 7B, according to this embodiment, when a user touches the touch-sensing display panel 200 with his or her finger, capacitance between the touch-sensing units 232 (capacitance between the first touch-sensing pads 242 and the second touch-sensing pads 252) is changed, and a signal indicating such a change is transmitted to a controller (not shown), so as to calculate the coordinate of the touched location. Thereby, an image displayed on the touch-sensing display panel 200 can be changed when the user selects a location to perform the touch action. In addition, when the touched location is in a region among the touch-sensing units 232 but not in an individual sensing unit 232, the controller, based on the signals retrieved by the touch-sensing units 232, performs interpolation to detect the accurate touched location, for instance.

Specifically, in this embodiment, the touch-sensing layer 230 is disposed corresponding to the display region 212 and extends out of the display region 212. Namely, the touch-sensing units 232 are disposed corresponding to the display region 212, and the auxiliary touch-sensing units 234 are disposed corresponding to the non-display region 214. Accordingly, even though the user's finger comes into contact with an edge area of the display image, i.e. the edge area of the display region 212, the controller is able to detect the accurate touched location by interpolation based on the signals retrieved by the touch-sensing units 232 and the auxiliary touch-sensing units 234. Thereby, the display images can be further changed. That is to say, in comparison with the conventional touch-sensing display panel that encounters an issue of not being able to recognize the touched location at the edge area of the display image, the touch-sensing display panel 200 of this embodiment is characterized by favorable touch-sensing capacity when the touch action is performed at the display region 212 and at the edge area of the display region 212. As such, it is much more convenient for the user to operate the touch-sensing display panel of the present invention.

Note that the touch-sensing layer 130 exemplarily described in the previous embodiment has the inner electrode series 140 and the outer electrode series 150 as depicted in FIG. 1B, and the touch-sensing layer 230 exemplarily described in the previous embodiment has the first touch-sensing series 240 and the second touch-sensing series 250 as depicted in FIG. 7B, which should not be construed as limitations to the present invention. According to other embodiments, the touch-sensing layer can have different touch-sensing structures well known to people having ordinary skill in the pertinent art.

In light of the foregoing, the touch-sensing layer of the touch-sensing display panel in the present invention overlaps the display region and the non-display region. Namely, the touch-sensing layer is disposed corresponding to the display region and extends out of the display region. Thereby, when the user touches the edge area of the display region, the touched location can still be detected. As such, the touch-sensing display panel of the present invention is characterized by favorable touch-sensing capacity. In particular, the touch-sensing layer of the touch-sensing display panel includes the touch-sensing units correspondingly disposed in the display region and the auxiliary touch-sensing units correspondingly disposed in the non-display region. Therefore, when the user's finger comes into contact with the edge area of the display region, the controller of the touch-sensing display panel can detect the accurate touched location by interpolation based on the signals retrieved by the touch-sensing units and the auxiliary touch-sensing units. Thereby, the display images can be further changed according to the user's selections. Consequently, in comparison with the conventional touch-sensing display panel that encounters an issue of not being able to recognize the touched location at the edge area of the display image, the touch-sensing display panel of the present invention is characterized by favorable touch-sensing capacity when the touch action is performed at the display region and at the edge area of the display region. As such, it is much more convenient for the user to operate the touch-sensing display panel of the present invention.

It will be apparent to those skilled in the art that various modifications and variations can be made to the structure of the present invention without departing from the scope or spirit of the present invention. In view of the foregoing, it is intended that the present invention cover modifications and variations of the present invention provided they fall within the scope of the following claims and their equivalents.

What is claimed is:

1. A touch-sensing display panel comprising:
a panel having a display region and a non-display region; and
a touch-sensing layer overlapping the display region and the non-display region.

2. The touch-sensing display panel as claimed in claim 1, wherein the touch-sensing layer comprises:
a plurality of first touch-sensing series extending along a first direction, each of the first touch-sensing series comprising a plurality of first touch-sensing pads electrically connected to one another; and
a plurality of second touch-sensing series extending along a second direction, each of the second touch-sensing series comprising a plurality of second touch-sensing pads electrically connected to one another, the first direction being different from the second direction, and the first touch-sensing series being electrically insulated from the second touch-sensing series.

3. The touch-sensing display panel as claimed in claim 2, wherein the first direction is substantially perpendicular to the second direction.

4. The touch-sensing display panel as claimed in claim 2, wherein a width of each of the first touch-sensing pads and the second touch-sensing pads ranges from about 0.7 cm to about 1.0 cm.

5. The touch-sensing display panel as claimed in claim 2, wherein the touch-sensing layer further comprises a patterned dielectric layer substantially located between the first touch-sensing series and the second touch-sensing series, and substantially located in the area of the intersections of the first touch-sensing series and the second touch-sensing series.

6. The touch-sensing display panel as claimed in claim 1, wherein the touch-sensing layer comprises:
a plurality of inner electrode series extending along a first direction, each of the inner electrode series comprising a plurality of inner electrodes electrically connected to one another; and
a plurality of outer electrode series extending along a second direction, each of the outer electrode series comprising a plurality of outer electrodes electrically connected to one another, each of the inner electrodes being respectively surrounded by one of the outer electrodes, and the first direction being different from the second direction, the inner electrode series being electrically insulated from the outer electrode series.

7. The touch-sensing display panel as claimed in claim 6, wherein the first direction is substantially perpendicular to the second direction.

8. The touch-sensing display panel as claimed in claim 6, wherein a width of each of the inner electrodes ranges from about 0.7 cm to about 1.0 cm.

9. The touch-sensing display panel as claimed in claim 6, wherein the touch-sensing layer further comprises a patterned dielectric layer located between intersections of the inner electrode series and the outer electrode series.

10. The touch-sensing display panel as claimed in claim 1, wherein the touch-sensing layer comprises:
a plurality of touch-sensing units correspondingly disposed within the display region; and
a plurality of auxiliary touch-sensing units correspondingly disposed within the non-display region.

11. The touch-sensing display panel as claimed in claim 10, wherein a width of each of the auxiliary touch-sensing units is substantially equal to or less than a width of each of the touch-sensing units.

12. The touch-sensing display panel as claimed in claim 11, wherein the width of each of the touch-sensing units ranges from about 0.7 cm to about 1.0 cm.

13. The touch-sensing display panel as claimed in claim 1, wherein the panel comprises:
an active device array substrate;
an opposite substrate; and
a display medium layer located between the active device array substrate and the opposite substrate.

14. The touch-sensing display panel as claimed in claim 13, wherein the touch-sensing layer is disposed on the opposite substrate, and the opposite substrate is located between the active device array substrate and the touch-sensing layer.

15. The touch-sensing display panel as claimed in claim 13 further comprising an auxiliary substrate, wherein the touch-sensing layer is disposed on the auxiliary substrate and located between the auxiliary substrate and the opposite substrate.

16. The touch-sensing display panel as claimed in claim 13, wherein the opposite substrate comprises a color filter substrate.

17. The touch-sensing display panel as claimed in claim 1, wherein the touch-sensing layer is located on the panel.

18. The touch-sensing display panel as claimed in claim 1, wherein the touch-sensing layer is located in the panel.
